(19) United States
(12) Patent Application Publication
(10) Pub. No.: US 2014/0372152 A1
(43) Pub. Date: Dec. 18, 2014

(54) System and Method of Calculating the Pricing of Credit Based on Engagement with a Driver Programme

(71) Applicant: Discovery Limited, Sandton (ZA)

(72) Inventors: Adam Ian Noach, Sandton (ZA); Darren Segal, Johannesburg (ZA); Robert Hutchinson-Keip, Johannesburg (ZA)

(21) Appl. No.: 14/363,928

(22) PCT Filed: Nov. 29, 2012
(86) PCT No.: PCT/IB2012/056827

§ 371 Date: Jun. 9, 2014

(30) Foreign Application Priority Data
Dec. 9, 2011 (ZA) 2011/09078

(51) Int. Cl. G06Q 40/08; G06Q 30/02

(52) U.S. Cl. CPC G06Q 40/08; G06Q 30/0207
USPC 705/4

(57) ABSTRACT

A system and method of calculating the pricing of credit based on engagement with a driver programme includes receiving data including information relating to the compliance of a driver in a plurality of programme areas related to motor vehicle driver behaviours and storing the data in a database. Points are awarded to the driver wherein the points allocated are related to the compliance of the driver in the programme areas and the points allocated are used as one factor to calculate the pricing of credit for the driver wherein the higher the degree of compliance with the programme the cheaper the pricing of the credit.

### BACKGROUND OF THE INVENTION

The present application relates to a system and method of calculating the pricing of credit based on engagement with a driver programme.

There is currently no use of the level of engagement with a driver programme as a tool to price credit.

However, people with the personality profile to properly engage a driver rewards programme have the same personality profile to properly manage their debt.

The present invention therefore provides a system and method of calculating the pricing of credit based on engagement with a driver programme.

### SUMMARY OF THE INVENTION

According to one example embodiment, a method of calculating the pricing of credit based on engagement with a driver programme, the method including:
receiving data including information relating to the compliance of a driver in a plurality of programme areas related to motor vehicle driver behaviours and storing the data in a database;
awarding points to the driver wherein the points allocated are related to the compliance of the driver in the programme areas; and
using the points allocated as one factor to calculate the pricing of credit for the driver wherein the higher the degree of compliance with the programme the cheaper the pricing of the credit.

The points allocated are used to determine a driver status, wherein the driver status is used as one factor to calculate the pricing of credit.

The plurality of programme areas may include at least some of vehicle maintenance, driver education, vehicle insurance claims and driving performance.

The plurality of programme areas may include all of vehicle maintenance, driver education, vehicle insurance claims and driving performance.

The programme area of vehicle maintenance typically includes one or more of servicing the vehicle, checking the vehicle and checking the vehicles tyres.

The programme area of driver education typically includes one or more of a driving course, a driver assessment, a periodic driver quiz and a carbon footprint calculation.

The programme area of vehicle insurance claims typically includes the number of claim free years.

The programme area of driving performance typically includes monitoring the manner in which a motor vehicle is driven.

The manner in which the motor vehicle is driven typically includes:
obtaining data from a device associated with a motor vehicle; and
analysing the data to determine the manner in which the motor vehicle has been driven for a past period;

According to another example embodiment, a system for calculating the pricing of credit based on engagement with a driver programme, the system including:
a receiving module for receiving data relating to the compliance of a driver in a plurality of programme areas related to motor vehicle driver behaviours;
a calculation module to award points to the driver wherein the points allocated are related to the compliance of the driver in the programme areas; and
a credit module to use the points allocated as one factor to calculate the pricing of credit for the driver wherein the higher the degree of compliance with the programme the cheaper the pricing of the credit.

The calculation module may uses the points allocated to determine a driver status, wherein the driver status is used as one factor to calculate the pricing of credit wherein the higher the degree of compliance with the programme the cheaper the pricing of the credit.

### BRIEF DESCRIPTION OF THE DRAWINGS

FIG. 1 is a block diagram illustrating an example system to implement the methodologies described herein;

FIG. 2 is a block diagram illustrating an example server in more detail; and

FIG. 3 is a flow chart illustrating the methodology of an example embodiment.

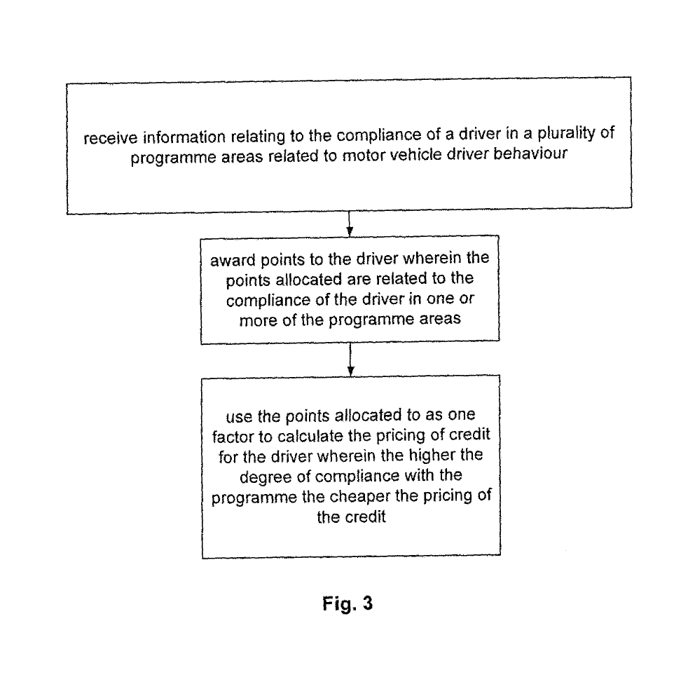

### DESCRIPTION OF EMBODIMENTS

The systems and methodology described herein relate to a system and method of calculating the pricing of credit based on engagement with a driver programme.

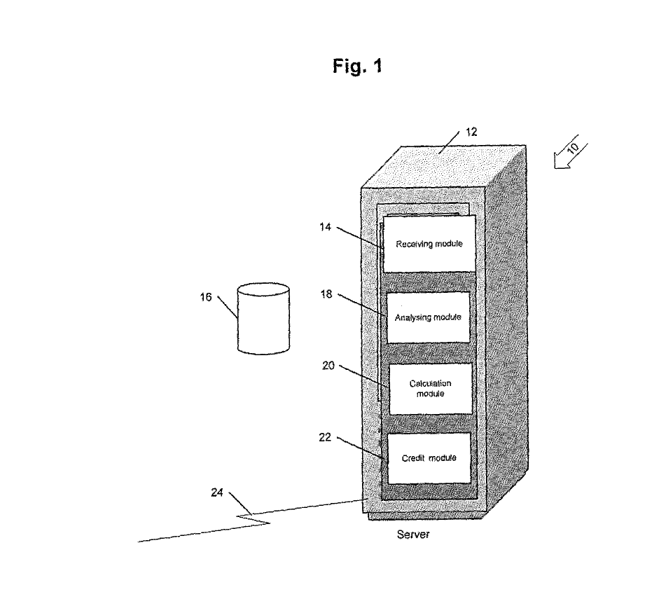

Referring to FIG. 1, an information processing system 10 may include a server 12 that includes a number of modules to implement the present invention.

In one example embodiment, the modules described below may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

In the illustrated example embodiment, the server 12 includes a receiving module 14 to receive data and to write the data to a memory 16.

The memory 16 is typically in the form of a database associated with the server 12.

The receiving module 14 receives compliance data containing information relating to the compliance of a driver in a plurality of programme areas related to motor vehicle driver behaviour.

The compliance data is stored in the database 16.

An analysing module 18 analyses the compliance data to determine driver behaviour. This will be described in more detail below.

A calculation module 20 awards points to the driver wherein the points allocated are related to the compliance of the driver in one or more of the programme areas. An example of this is described below.

Finally, the points allocated are used by a credit module 22 to determine a calculating the pricing of credit for the driver.

The plurality of programme areas includes at least some of vehicle maintenance, driver education, vehicle insurance claims, premium payments, policy updates and driving performance.

In one example embodiment, the plurality of programme areas includes all of the abovementioned programme areas.

The programme area of vehicle maintenance includes one or more of servicing the vehicle, checking the vehicle and checking the vehicles tyres.

Describing these programme areas in more detail, servicing the vehicle means that the driver has taken the vehicle to a mechanical workshop for a periodic service to ensure that the vehicle is in good working order. Typically in such services oil and other lubricants are changed, brake pads are changed if required and any other mechanical faults that have arisen in the past period are fixed.

The programme area of checking the vehicle entails taking the vehicle to an authorised centre were a number of checks on the different parts of the vehicle are conducted to ensure that the vehicle is in good working order. If anything is found to be not correct, the driver will be instructed to take the vehicle to a workshop for fixing and may be awarded further points for this step.

New vehicles may be exempt from the service check for the first year and the insured person will be awarded these points on submission of proof that the vehicle is within its first year since its first registration.

Checking the vehicle tyres entails either having the tyres checked as part of the above-mentioned checking of the vehicle or alternatively, taking the vehicle to a specialist tyre centre to have the tyres checked.

In one example embodiment, an interface is created between the server 12 and checking centre via the communications network 24 so that the checking centre can confirm the results of the check.

In addition to the tyre check the steering, windscreen wipers, lights, seatbelts, hooter and shock absorbers can be checked at this time.

Bonus Points can be awarded for all of these being in an acceptable condition.

In all of these cases, the party doing the checking or servicing will capture data relating to the vehicle and/or driver and periodically transmit this data to the receiving module 14.

The programme area of driver education includes one or more of a driving course, a driver assessment, a periodic driver quiz and a carbon footprint calculation.

Driving courses are attended by drivers to improve their driving skills and particularly to learn so-called defensive driving skills,

A driver assessment is conducted in one example embodiment by an assessor taking the driver in the vehicle onto the road and assessing the driving skills and habits of the driver.

Weaknesses in the skills or habits of the driver may be pointed out and the driver given the opportunity to correct these in the coming weeks or months before returning for an updated assessment.

In one example, the driver is given an assessment score.

In another example, the driver assessment is an online questionnaire designed to highlight certain risks relating to a driver.

In this example, the questionnaire includes two sections namely. Driving habits' and ‘State of Vehicle’. For example a question of whether one uses a cellular telephone to send messages while driving will be asked. At the end of the questionnaire (approximately 20 questions) the driver will receive feedback explaining their risk and suggesting ways to mitigate their risks.

Based on the answers received a calculation will be performed to consider the driver's risk relative to an average driver. The results can be illustrated to the driver on two risk bars. One illustrates how risky the driver's habits are, and one illustrates risks relating to the state of the drivers vehicle.

A third risk bar may also be included illustrating a combined risk score.

In addition, the questionnaire may include educational information to address specific areas such as how to drive in wet weather or what to do in the event of an accident. The format will be a paragraph followed by a question relating to the paragraph

In this example, the driver will typically use a user interface device in the form of a computer with a screen on which is displayed a template for the driver to capture answers to questions put to them.

The answers are captured and transmitted to the server 12.

Alternatively, the server 12 accesses driver information stored in the database 16 and obtains the driver's e-mail address.

An e-mail is then sent to the retrieved e-mail address. When the driver opens the e-mail a template is displayed to them asking them the relevant questions with options to select various scores.

A driver will send the e-mail back to the server 12 via a communications network and the receiving module 16. These will be received and written to the database.

The programme area of premium payments relates to the quantum and frequency with which premium payments are made to a motor vehicle insurer and if they are made on time or not and the programme area of policy updates relates to whether or not the driver is updating their policy to accurately reflect what is being insured by the insured person.

The programme area of vehicle insurance claims includes the number of claim free years. No fault claims where the driver was not at fault typically will not be calculated as a claim for this.

The programme area of driving score includes monitoring the manner in which the motor vehicle is driven.

In one example embodiment this is implemented using data received from a telematics device 26 associated with the vehicle 28 which is the vehicle driven by the driver taking part in the programme. It will be appreciated that in one example the telemetry device 12 will be installed in the motor vehicle either at the time of production or retro-fitted.

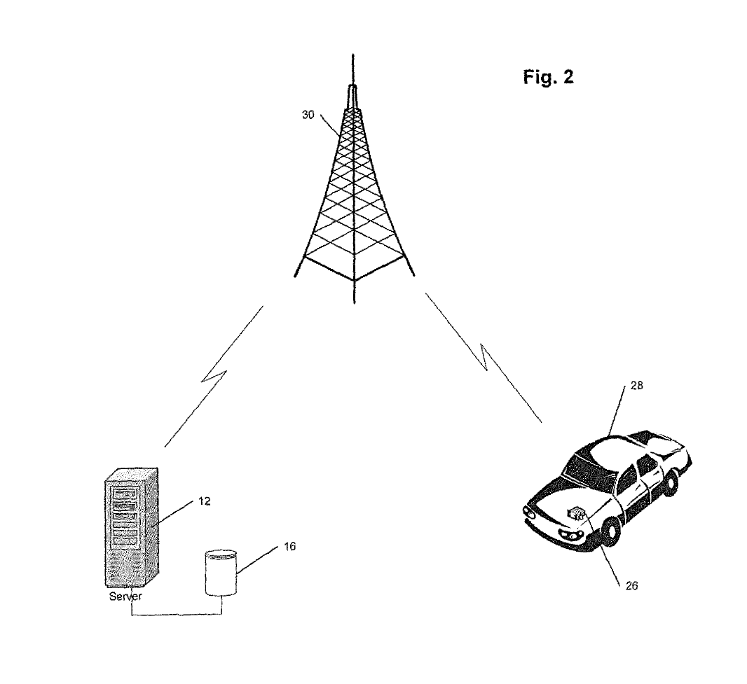

In any event, referring to FIG. 2, a motor vehicle 28 is fitted with the telemetry device 26.

The telemetry device 26 is used to monitor a number of aspects of the use of the motor vehicle.

For example, the device monitors the speed at which the vehicle is travelling and can therefore calculate average speed and maximum and minimum speeds, for example.

Where the device includes GPS functionality, for example, the device is able to determine if speed limits on a particular road have been exceeded.

The device is also able to determine braking habits of the driver either using the GPS functionality or by using an accelerometer or having one or more sensors connected to the vehicle or to a deceleration detection device, for example.

The device is also typically able to detect the distance travelled and if the driver has driven the vehicle for a long time period without a break.

In addition, the times of the day that the vehicle is being driven can be captured as night time driving is statistically more dangerous than day time driving, especially weekend late night driving.

In addition to the above, the device will have the ability to detect the driver's use of the vehicle including braking, indicating, cornering and accelerating to name a few examples. Thus it could be determined when the vehicle turns without indicating, for example.

In any event, the data from the device is transmitted to the server 12 over a communication network 30.

It will be appreciated that this could be accomplished in a number of ways. For example, the data could be transmitted via a communication network 30 as illustrated in the accompanying drawing. This communication network could be any suitable kind of communication network such as a mobile communication network, a wireless communication network, a satellite communication network or a combination of these to name but a few examples.

Alternatively, the device 26 could be connected to another intermediate device which downloads the data and transmits the data via the communication network 30 to the server 12. One example of this could be connecting the device 26 to a USB port of a computer and downloading the data to the computer, which data is then transmitted over the Internet to the server 12.

In one example embodiment, the data is transmitted over a mobile phone network using the short message service (SMS) protocol.

It will be appreciated that the data could be transmitted at any suitable time to the server. For example, the data could be transmitted in real time or near real time or could be transmitted periodically such as daily, weekly or monthly to name a few examples.

Once the server 12 receives the data it will analyse the data to determine the manner in which the motor vehicle has been driven for a past predetermined period.

To do this the analysing module 18 accesses the memory 16 and retrieves the data stored therein.

The retrieved data is then used to determine a driving score. For example, the driver starts on a higher number of points which is reduced for each driving infraction, such as each harsh braking, speeding or late night driving instance as can be predetermined by the system managers.

An example of how the calculation module 20 then awards points is as follows:

| Driver Category | Points | Frequency |
|---|---|---|
| Driving score | | |
| No Star (no telematics device) | | Monthly |
| * | — | |
| ** | 100 | |
| *** | 350 | |
| **** | 800 | |
| Road worthy | | |
| Annual Service | 50 | Annual |
| Multi Point Check | 50 | |
| Multi point check bonus points | 100 | |
| Education | | |
| Defensive driving course | 150 | Every 3 |
| | | years |
| Driver Assessment | 50 | Annual |
| Quarterly quiz | 75 | ¼ly |
| Carbon footprint calculated | 50 | Monthly |
| Claim Free Years | | |
| 1 | 25 | Monthly |
| 2 | 50 | |
| 3+ | 100 | |

It will be appreciated that the actual number of points allocated may change and other categories may be introduced.

In one example embodiment the number of points is used to determine a driver status. An example driver status is as follows:

| Driver Status | |
|---|---|
| Base | 0 |
| Neutral | 300 |
| Engaged | 600 |
| Advanced | 1000 |

It will be appreciated that the way in which the points are allocated and driver status determined could be varied. However, in an example embodiment the status will be determined periodically, for example every month.

At the beginning of every calendar month the driver's points are zeroed and drivers will then be awarded points for having done a multi point check, annual service, driver assessment or carbon footprint calculation within the previous 12 months.

Similarly quarterly quiz points will be awarded provided the questionnaire has been done for that quarter.

Defensive driving courses need to be completed every 3 years or any other specified period to earn points and if a defensive driving course has been completed in the past 3 years then the relevant points will be added to the driver score for the present month.

If confirmation of these point earning events are received midmonth then points will be awarded immediately therefore contributing to the driver status in that month.

On the last day of each month the driver's telematic data or a telematic score will be received and points award points accordingly.

In addition, reminders are sent out when a roadworthy check or tyre check is required via the communication network 24.

At periodic intervals using the driver status as one factor to calculate the pricing of credit wherein the higher the degree of compliance with the driver programme the cheaper the pricing of the credit.

| | Probability of default on |
|---|---|
| How you drive | loan (credit risk) |
| Base | 5% |
| Neutral | 4.5% |
| Engaged | 4.2% |
| Advanced | 3% |

The methodology then uses this seemingly unrelated information to improve credit models and to differentiate rates based on how the driver drivers.

This information give unique insights into the driver's attitude to risk and their level of responsibility on the whole. It also allows a varying of the driver's rates regularly as their driving is monitored without having to request additional information from the driver.

In one example, the pricing of the credit will be reviewed periodically.

For example, the period could be monthly wherein the greater the status achieved in the previous month the cheaper the credit.

Once the pricing of credit has been determined, the credit module 22 then effects the pricing of the credit. In one example embodiment this could be done by communicating with a financial institution via the communications network 24 and instructing the financial institution to implement the credit pricing.

An example of the pricing of credit could be as follows. Where the interest rate on credit is set by a central bank in a country and typically referred to as prime interest rate, the pricing of credit is determined as follows:

| How you drive | Change to Prime Interest Rate |
|---|---|
| Base | +1% |
| Neutral | 0% |
| Engaged | −0.5% |
| Advanced | −1% |

It will be appreciated that the person that is at base level is actually charged more interest than the market value as they are identified as being a higher than normal credit risk profile based on their driving habits.

Thus it will be appreciated that the present invention provides a method of using the compliance of a driver with the programme to assess their credit risk and to price their credit accordingly.

1. A method of calculating the pricing of credit based on engagement with a driver programme, the method including:
receiving, with a computer, data including information relating to the compliance of a driver in a plurality of programme areas related to motor vehicle driver behaviours and storing the data in a database;
awarding, with a computer, points to the driver wherein the points allocated are related to the compliance of the driver in the programme areas; and
using the points allocated as one factor to calculate, with a computer, the pricing of credit for the driver wherein the higher the degree of compliance with the programme the cheaper the pricing of the credit.

2. A method according to claim 1 wherein the points allocated are used to determine a driver status, wherein the driver status is used as one factor to calculate, with a computer, the pricing of credit.

3. A method according to claim 1 wherein the plurality of programme areas include at least some of vehicle maintenance, driver education, vehicle insurance claims and driving performance.

4. A method according to claim 1 wherein the plurality of programme areas include all of vehicle maintenance, driver education, vehicle insurance claims and driving performance.

5. A method according to claim 3 wherein the programme area of vehicle maintenance includes one or more of servicing the vehicle, checking the vehicle and checking the vehicles tyres.

6. A method according to claim 3 wherein the programme area of driver education includes one or more of a driving course, a driver assessment, a periodic driver quiz and a carbon footprint calculation.

7. A method according to claim 3 wherein the programme area of vehicle insurance claims includes the number of claim free years.

8. A method according to claim 3 wherein the programme area of driving performance includes monitoring the manner in which a motor vehicle is driven.

9. A method according to claim 8 wherein monitoring the manner in which the motor vehicle is driven includes:
obtaining, with a computer, data from a device associated with a motor vehicle; and
analysing, with a computer, the data to determine the manner in which the motor vehicle has been driven for a past period.

10. A computer system for calculating the pricing of credit based on engagement with a driver programme, the system including:
a receiving module for receiving data relating to the compliance of a driver in a plurality of programme areas related to motor vehicle driver behaviours;
a calculation module to award points to the driver wherein the points allocated are related to the compliance of the driver in the programme areas; and
a credit module to use the points allocated as one factor to calculate the pricing of credit for the driver wherein the higher the degree of compliance with the programme the cheaper the pricing of the credit.

11. A system according to claim 10 wherein the calculation module uses the points allocated to determine a driver status, wherein the driver status is used as one factor to calculate the pricing of credit wherein the higher the degree of compliance with the programme the cheaper the pricing of the credit.

12. A system according to claim 10 wherein the plurality of programme areas include at least some of vehicle maintenance, driver education, vehicle insurance claims and driving performance.

13. A system according to claim 10 wherein the plurality of programme areas include all of vehicle maintenance, driver education, vehicle insurance claims and driving performance.

14. A system according to claim 10 wherein the programme area of vehicle maintenance includes one or more of servicing the vehicle, checking the vehicle and checking the vehicles tyres.

15. A system according to claim 10 wherein the programme area of driver education includes one or more of a driving course, a driver assessment, a periodic driver quiz and a carbon footprint calculation.

16. A system according to claim 10 wherein the programme area of vehicle insurance claims includes the number of claim free years.

17. A system according to claim 10 wherein the programme area of driving score includes monitoring the manner in which the motor vehicle is driven.

18. A system according to claim 17 further wherein:
the receiving module obtains driver data from a device associated with a motor vehicle; and
the analysing module analyses the data to determine the manner in which the motor vehicle has been driven for a past period.
